(19) United States
(12) Patent Application Publication
(10) Pub. No.: US 2025/0367790 A1
(43) Pub. Date: Dec. 4, 2025

(54) MULTI-CALIBER SELF-TIGHTENING LOWER RECEIVER VISE BLOCK

(71) Applicant: Strike IP LLC

(72) Inventors: Shanyao Lee, Las Vegas, NV (US); Hung Ju Lee, Taipei (TW)

(21) Appl. No.: 18/680,338

(22) Filed: May 31, 2024

(51) Int. Cl. B25B 1/06; F41A 23/18

(52) U.S. Cl. CPC B25B 1/06; F41A 23/18

(57) ABSTRACT

A multi-caliber self-tightening vise block for a lower receiver of a firearm includes a main body having a first section, a second section integrally extended from the first section, a middle portion formed between the first section and the second section, and an opening cavity formed on the middle portion; and an affixing assembly pivotally coupled with the main body; wherein the affixing assembly includes a first polymer lever, a second polymer lever, and an affixing pin configured to pivotally coupled the first polymer lever with the second polymer lever on the main body.

### FIELD OF THE DISCLOSURE

The present disclosure relates to a vise block for a firearm's lower receiver, and more particularly, to a universal vise block having a multi-caliber configuration and a self-tightening function.

### BACKGROUND OF THE DISCLOSURE

Traditionally, the vise block is designed to be inserted into the magazine well and allowed to be clamped in a vise holder, and the vise block is only designed for use with certain types of firearm's lower receiver, such as only for AR-15 lower receiver. To solve this problem, an improved AR15 vise block with a vise block sleeve for AR 10 is provided in the current market. Since the magwell sizes have a notoriously wide range of tolerances, and the traditional blocks create wiggle and wobble on a gun vise. The improved designs solve the above problems. The improved design provides a rotatable adjustment handle to expand its inside design to fit all MIL-SPEC AR15s, AR10s, and similar magwells.

However, the designs as mentioned above have several drawbacks. First, it is a hassle for the user to carry a separate type of vise-block sleeve for different purposes. Second, rotating the adjustment handle to expand the block body for fitting the magwells may eventually damage the magwells.

There may be a desire to provide an all-in-one vise block that enables the user to apply with multiple calibers of a firearm and has a self-tightening function without applying additional tools.

All referenced patents, applications and literatures are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The disclosed embodiments may seek to satisfy one or more of the above-mentioned desires. Although the present embodiments may obviate one or more of the above-mentioned desires, it should be understood that some aspects of the embodiments might not necessarily prevent them.

### BRIEF SUMMARY OF THE DISCLOSURE

In a general implementation, a multi-caliber self-tightening vise block for a lower receiver of a firearm may comprise a main body having a first section, a second section integrally extended from the first section, a middle portion formed between the first section and the second section, and an opening cavity formed on the middle portion; and an affixing assembly pivotally coupled with the main body; wherein the affixing assembly comprises a first polymer lever, a second polymer lever, and an affixing pin configured to pivotally coupled the first polymer lever with the second polymer lever on the main body.

In another aspect combinable with the general implementation, the first polymer lever comprises a first main portion received inside the opening cavity, and the second polymer lever comprises a second main portion received inside the opening cavity, wherein the first main portion is aligned with the second main portion.

Among the many possible implementations of the vise block, wherein the first polymer lever comprises a first right wing upwardly and integrally extended from one side of a first main portion and a first left wing upwardly and integrally extended from the other side of the first main portion, wherein the second polymer lever comprises a second right wing upwardly and integrally extended from one side of a second main portion and a second left wing upwardly and integrally extended from the other side of the second main portion.

Further, it is contemplated that the main body comprises a front side portion and a rear side portion formed on an opposite side of the front side portion, wherein the first polymer lever is arranged on the front side portion and the second polymer lever is arranged on the rear side portion.

In the alternative, the middle portion of the main body has a middle through hole, and the first polymer lever comprises a first main portion having a first through hole, and the second polymer lever comprises a second main portion having a second through hole, wherein the affixing pin is passed through the middle through hole, the first through hole, and the second through hole.

It is still further contemplated that the first section comprises a first width defined between a first free end to a second free end, and the second section comprises a second width defined between a third free end to a fourth free end, wherein the second width is longer than the first width.

In another aspect combinable with the general implementation, the main body comprises a front face, a rear face formed on an opposite side of the front face, a left face integrally extended between the front face and the rear face and defining a left length, and a first right face defining a first right length, wherein the left length is longer than the first right length.

In another aspect combinable with the general implementation, the second section comprises a first right face inwardly and vertically indented to form a first front face, wherein the first front face is vertically extended towards a front face of the main body to form a second right face, wherein the first front face and the second right face define an indented section.

In another aspect combinable with the general implementation, the first polymer lever comprises a first right wing integrally extended to form a first left wing of the first polymer lever, wherein the second polymer lever comprises a second right wing integrally extended to form a second left wing of the second polymer lever, wherein the first section is squeezed between a pair of vise holders, wherein the first left wing and the second left wing are squeezed by the pair of the vise holders.

In another aspect combinable with the general implementation, the second section is inserted into the lower receiver, wherein the first right wing and the second right wing are guided to be biased against the lower receiver to lock the lower receiver of the firearm on the second section of the main body.

In another aspect combinable with the general implementation, the first polymer lever comprises a first right wing integrally extended to form a first left wing, wherein the second polymer lever comprises a second right wing integrally extended to form a second left wing, wherein the second section is squeezed between a pair of vise holders, wherein the first right wing and the second right wing are squeezed by the pair of the vise holders.

In another aspect combinable with the general implementation, the first section is inserted into the lower receiver, wherein the first left wing and the second left wing are guided to be biased against the lower receiver to lock the firearm's lower receiver on the first section of the main body.

Another aspect of the embodiment is directed to methods of using a vise block for self-tightening a lower receiver of a firearm on a pair of vise holders, comprising:
pivotally coupling a first polymer lever with a second polymer lever on a main body of the vise block by an affixing pin;
inserting a second section of the main body of the vise block into the lower receiver of the firearm;
squeezing a first section of the main body of the vise block between a pair of the vise holders; and
guiding and being biased against a first left wing of the first polymer lever and a second left wing of the second polymer lever towards the lower receiver of the firearm to lock the lower receiver of the firearm with the second section of the main body.

In another aspect combinable with the general implementation, the step of pivotally coupling the first polymer lever with the second polymer lever on the main body of the vise block by the affixing pin comprises steps of:
aligning a first main portion of the first polymer lever with a second main portion of the second polymer lever;
deposing the first main portion and the second main portion inside an opening cavity formed on a middle portion of the main body;
arranging the first polymer lever on a first side portion of the main body;
arranging the second polymer lever on a rear side portion of the main body; and
passing the affixing pin through a middle through hole of a middle portion of the main body, a first through hole of the first main portion, and a second through hole of the second main portion; wherein
the middle portion of the main body is formed between the first section and the second section and the rear side portion is formed on an opposite side of the front side portion.

In another aspect combinable with the general implementation, the step of inserting the second section of the main body of the vise block into the lower receiver of the firearm comprises steps of:
squeezing a first right wing of the first polymer lever and a second right wing of the second polymer lever by the pair of the vise holders; wherein
the first right wing is integrally extended to form the first left wing, and the second right wing is integrally extended to form the second left wing.

In another aspect combinable with the general implementation, methods of using the vise block for self-tightening the lower receiver of the firearm on the pair of vise holders may further comprise steps of:
inserting the first section into the lower receiver;
squeezing the second section of the main body by the pair of vise holders;
squeezing the first left wing of the first polymer lever and the second left wing of the second polymer lever by the pair of the vise holders; and
guiding the first right wing of the first polymer lever and the second right wing of the second polymer lever to be biased against the lower receiver of the firearm.

In another aspect combinable with the general implementation, the first right wing of the first polymer lever is upwardly and integrally extended from one side of a first main portion of the first polymer lever and a first left wing of the first polymer lever is upwardly and integrally extended from the other side of the first main portion, wherein a second right wing of the second polymer lever is upwardly and integrally extended from one side of a second main portion of the second polymer lever and a second left wing is upwardly and integrally extended from the other side of the second main portion.

In another aspect combinable with the general implementation, the first section comprises a first width defined between a first free end to a second free end and the second section comprises a second width defined between a third free end to a fourth free end, wherein the second width is longer than the first width.

In another aspect combinable with the general implementation, the main body comprises a front face, a rear face formed on an opposite side of the front face, a left face integrally extended between the front face and the rear face and defining a left length, and a first right face defining a first right length, wherein the left length is longer than the first right length.

In another aspect combinable with the general implementation, the second section comprises a first right face inwardly and vertically indented to form a first front face, wherein the first front face is vertically extended towards a front face of the main body to form a second right face, wherein the first front face and the second right face define an indented section.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation.

Conversely, various features that are described in the context of a single implementation can also be implemented in multiple implementations separately or in any suitable subcombination. Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, the operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be of a precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a perspective view of a multi-caliber self-tightening lower receiver vise block according to an aspect of the embodiment.

FIG. 2 is an exploded view of a multi-caliber self-tightening lower receiver vise block according to an aspect of the embodiment.

FIG. 3 is a sectional view of an affixing assembly according to an aspect of the embodiment.

FIG. 4 is a top view of the multi-caliber self-tightening lower receiver vise block according to an aspect of the embodiment.

FIG. 5 is a side view of the multi-caliber self-tightening lower receiver vise block according to an aspect of the embodiment.

FIG. 6 illustrates a method of using the vise block for self-tightening the lower receiver of the firearm on the pair of vise holders according to an aspect of the embodiment.

FIG. 7 illustrates further steps of the method of using the vise block for self-tightening the lower receiver of the firearm on the pair of vise holders according to an aspect of the embodiment.

FIG. 8 illustrates further steps of the method of using the vise block for self-tightening the lower receiver of the firearm on the pair of vise holders according to an aspect of the embodiment.

FIG. 9 illustrates further steps of the method of using the vise block for self-tightening the lower receiver of the firearm on the pair of vise holders according to an aspect of the embodiment.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

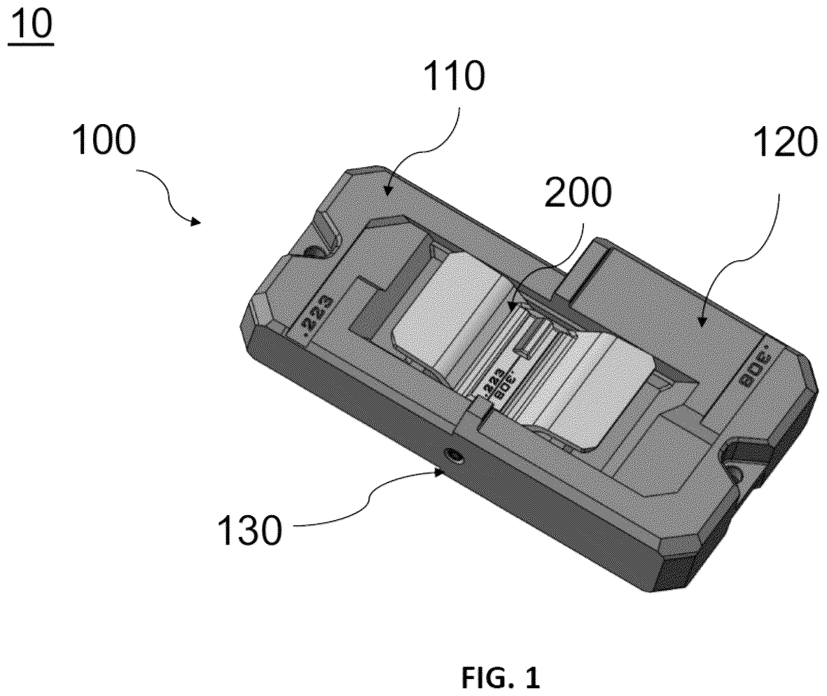

FIG. 1 generally depicts the multi-caliber self-tightening vise block 10 for a lower receiver of a firearm according to an aspect of the embodiment.

Referring to FIG. 1 of the drawings, the multi-caliber self-tightening vise block 10 for the lower receiver of the firearm may comprise a main body 100 having a first section 110, a second section 120 integrally extended from the first section 110, a middle portion 130 formed between the first section 110 and the second section 120.

In some embodiments, the multi-caliber self-tightening vise block 10 for the lower receiver of the firearm may comprise an affixing assembly 200 pivotally coupled with the main body 100.

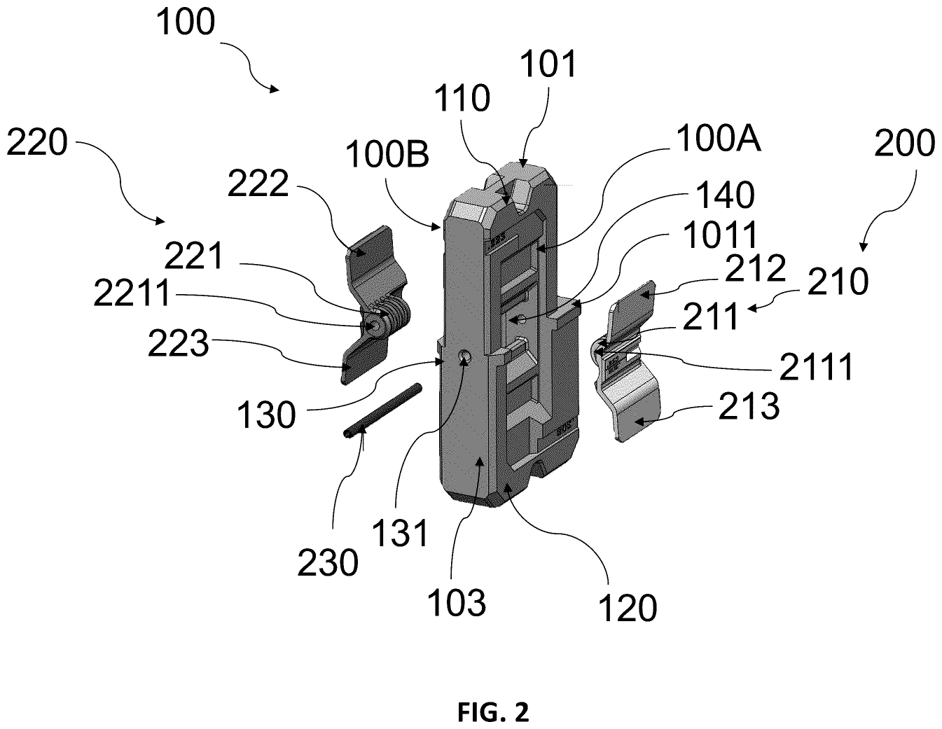

FIG. 2 generally depicts an exploded view of the multi-caliber self-tightening vise block 10 for the lower receiver of the firearm according to an aspect of the embodiment.

Referring to FIG. 2 of the drawings, the main body 100 may comprise an opening cavity 140 formed on the middle portion 130. In some embodiments, the affixing assembly 200 comprises a first polymer lever 210, a second polymer lever 220, and an affixing pin 230 configured to pivotally couple the first polymer lever 210 with the second polymer lever 220 on the main body 100.

As shown in further detail in FIG. 2, the first polymer lever 210 may comprise a first main portion 211 received inside the opening cavity 140 and the second polymer lever 220 comprises a second main portion 221 received inside the opening cavity 140.

In some embodiments, the first polymer lever 210 may comprise a first right wing 212 upwardly and integrally extended from one side of the first main portion 211 and a first left wing 213 upwardly and integrally extended from the other side of the first main portion 211, wherein the second polymer lever 220 comprises a second right wing 222 upwardly and integrally extended from a second main portion 221 and a second left wing 223 upwardly and integrally extended from the second main portion 221.

In still some embodiments, the main body 100 may comprise a front side portion 100A and a rear side portion 100B formed on an opposite side of the front side portion 100A, wherein the first polymer lever 210 is arranged on the front side portion 100A and the second polymer lever 220 is arranged on the rear side portion 100B.

It should be noted that, in some embodiments, the middle portion 130 of the main body 100 has a middle through hole 131, and the first main portion 211 of the first polymer lever 210 has a first through hole 2111, and the second main portion 221 of the second polymer lever 220 has a second through hole 2211, wherein the affixing pin 230 may be passed through the middle through hole 131, the first through hole 2111, and the second through hole 2211 to pivotally couple the first polymer lever 210 and the second polymer lever 220 with the middle portion 130 of the main body 100.

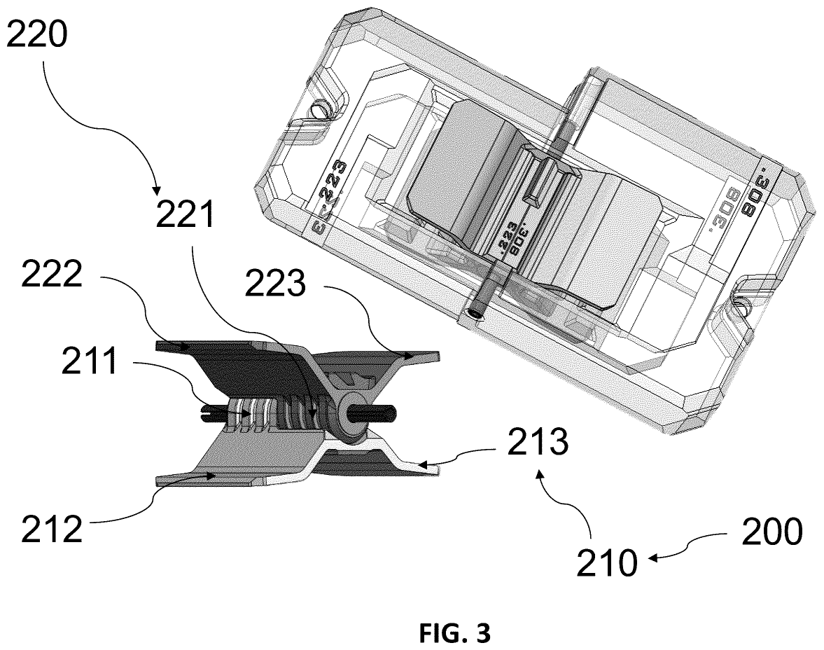

FIG. 3 generally depicts the affixing assembly 200 according to an aspect of the embodiments.

Referring to FIG. 3, in some embodiments, the first polymer lever 210 may comprise the first right wing 212 upwardly and integrally extended from one side of the first main portion 211 and the first left wing 213 upwardly and integrally extended from the other side of the first main portion 211, wherein the second polymer lever 220 may comprise the second right wing 222 upwardly and integrally extended from one side of the second main portion 221 and the second left wing 223 upwardly and integrally extended from the other side of the second main portion 221.

As shown in further detail in FIG. 3, the first main portion 211 may be aligned with the second main portion 221 and be deposed inside the opening cavity 140 (as shown in FIG. 2).

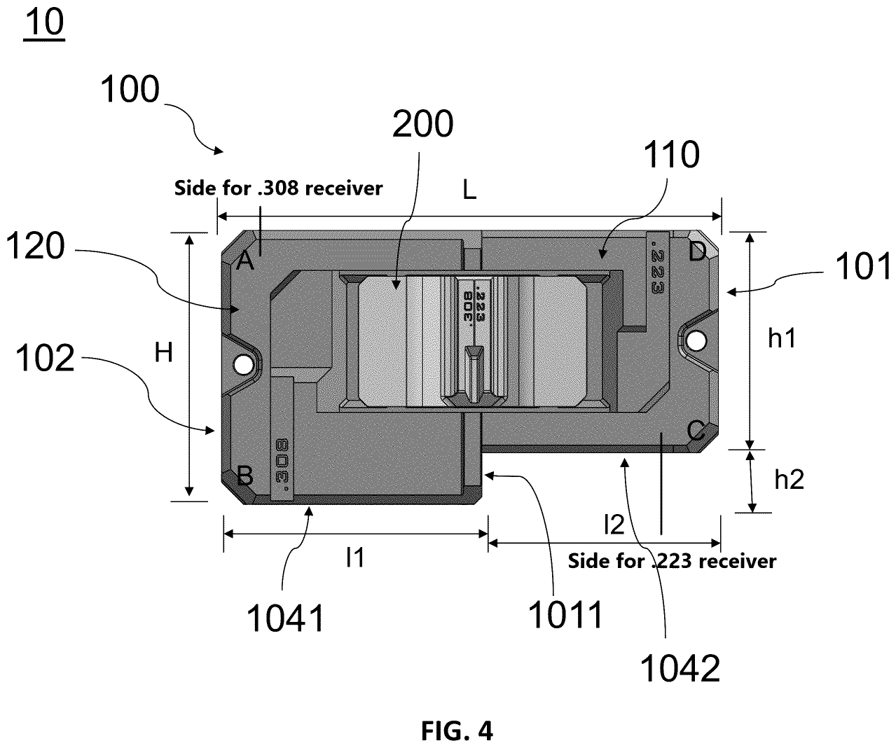

FIG. 4 generally shows a top view of the multi-caliber self-tightening vise block 10 for the lower receiver of the firearm according to an aspect of the embodiment.

Referring to FIG. 4, the first section 110 may comprise a first width “h1” defined between a first free end “D” to a second free end “C” and the second section 120 comprises a second width “H” defined between a third free end “B” to a fourth free end “A”, wherein the second width “H” is longer than the first width “h1”.

Referring back to FIGS. 2-4, the main body 100 may comprise a front face 101 defining the first width “h1”, a rear face 102 formed on an opposite side of the front face 101 and defining the second width “H”, a left face 103 integrally extended between the front face 101 and the rear face 102 and defining a left length “L”, and a first right face 1041 defining a first right length “l1”, wherein the left length “L” is longer than the first right length “l1”.

In still some embodiments, the second section 120 may comprise the first right face 1041 inwardly and vertically indented to form a first front face 1011, wherein the first front face 1011 is vertically extended towards the front face 101 of the main body 100 to form a second right face 1042, wherein the second right face 1042 may be vertically and integrally to form the front face 101.

In still some embodiments, the first front face 1011 and the second right face 1042 define an indented section, wherein the second right face 1042 defines a second right length “l2”, wherein the left length “L” may be equal to a total of the first right length “l1” and the second right length “l2”.

It should be noted that the front face 101 may define the first width “h1”, and the first front face 1011 may define a third width “h2”, wherein the first width “h1” is longer than the third width “h2”. In some embodiments, the second width “H” may be equal to a total of the first width “h1” and the third width “h2”.

Continuing to FIG. 4, the first section 110 may be configured to incorporate with an AR-15 (.223) lower receiver and the second section 120 may be configured to incorporate with an AR-10/M5 (.308) lower receiver.

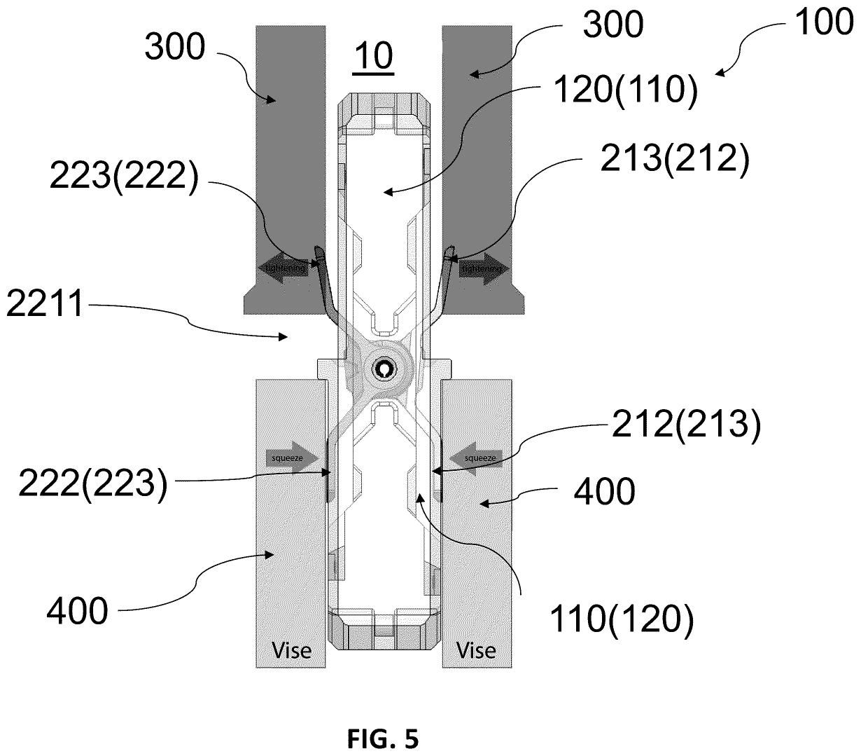

FIG. 5 generally depicts the multi-caliber self-tightening vise block 10 incorporated with the lower receiver 300 of the firearm according to an aspect of the embodiment.

In some embodiments, the first section 110 may be squeezed between a pair of vise holders 400, and in this situation, the first right wing 212 and the second right wing 222 may be squeezed by the pair of the vise holders.

In still some embodiments, while the first right wing 212 and the second wight wing 222 are squeezed by the pair of the vise holders 400, the second section 120 may be inserted into the lower receiver (the M5/AR 10 (.308) lower receiver) 300, and in this situation, the first left wing 213 and the second left wing 223 may be guided to be biased against the lower receiver (the M5 (.308) lower receiver) 300 to lock the lower receiver (the M5 (.308) lower receiver) 300 of the firearm with the second section 120 of the main body 100.

Alternatively, in still some embodiments, the second section 120 may be squeezed between the pair of vise holders 400. At the same time, the first left wing 213 and the second left wing 223 may be squeezed by the pair of the vise holders 400. In such a situation, the first section 110 may be inserted into the lower receiver (the AR-15 (.223) lower receiver) 300, wherein while the first left wing 213 and the second left wing 223 are squeezed by the pair of the vise holders 400, the first right wing 212 and the second right wing 222 may be guided to be biased against the lower receiver (the AR-15 (.223) lower receiver) 300 to lock the lower receiver (the AR-15 (.223) lower receiver) 300 of the firearm with the first section 110 of the main body 100.

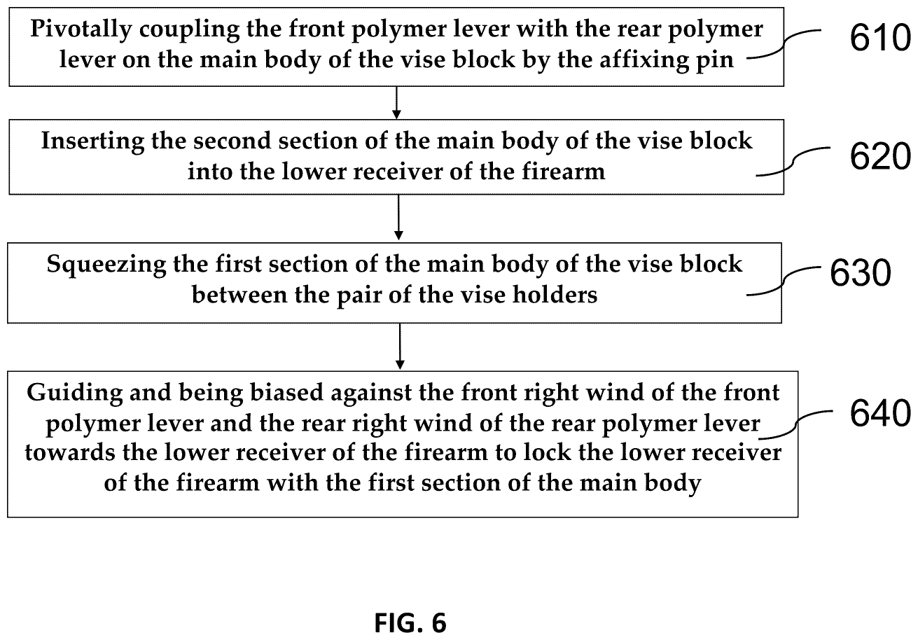

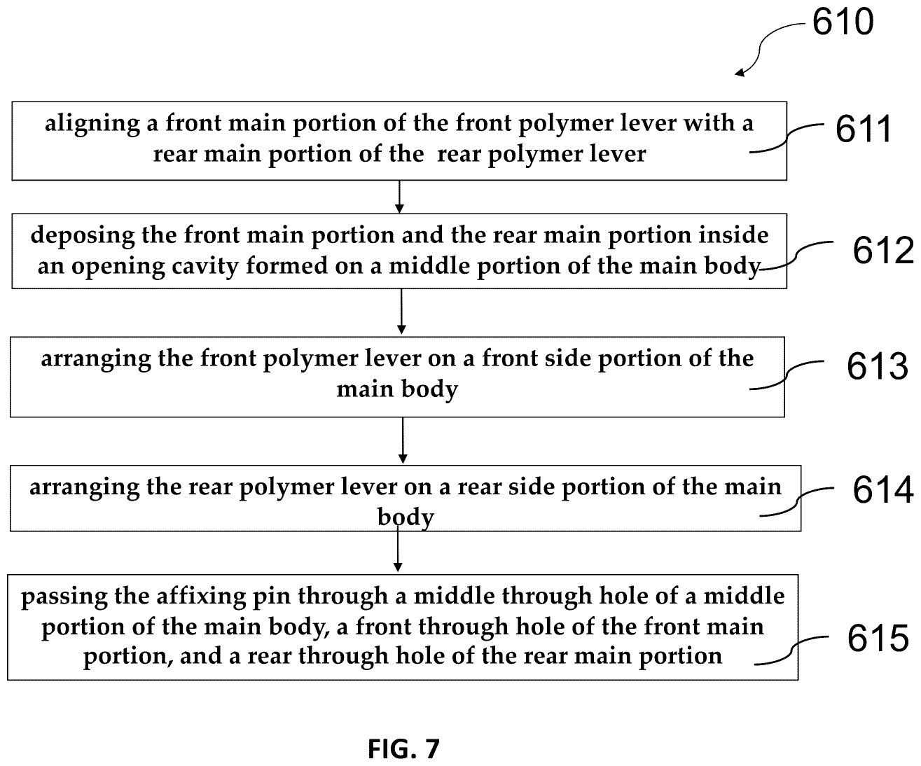

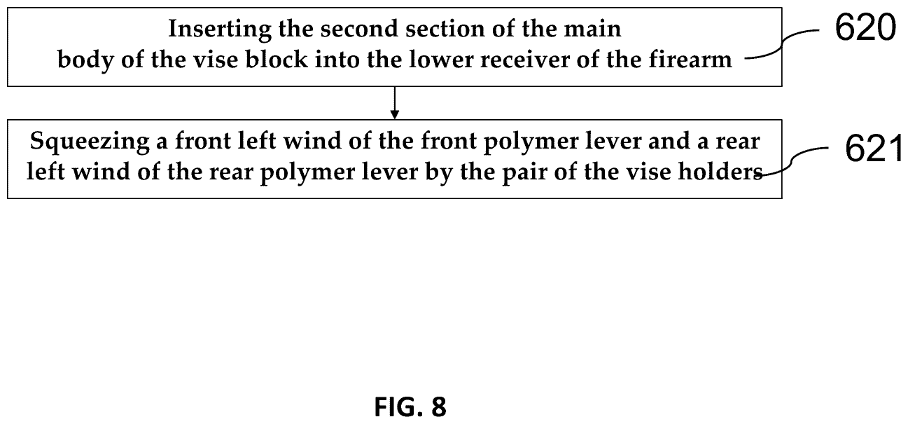

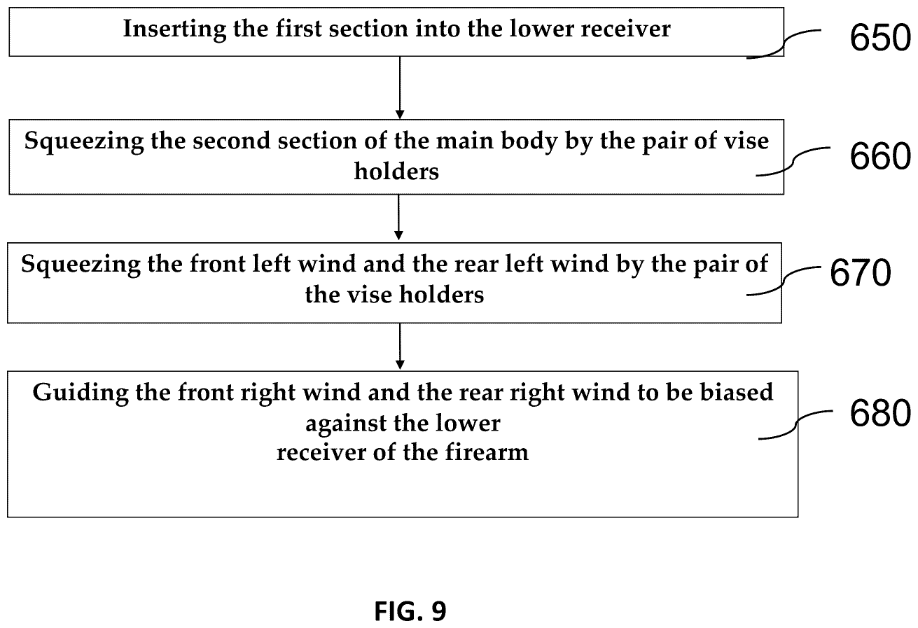

Referring to FIG. 6-FIG. 9 of the drawings, the contemplated embodiment may include a method of using the vise block for self-tightening the lower receiver of the firearm on the pair of vise holders may comprise steps of:
pivotally coupling the first polymer lever with the second polymer lever on the main body of the vise block by the affixing pin 610;
inserting the second section of the main body of the vise block into the lower receiver of the firearm 620;
squeezing the first section of the main body of the vise block between the pair of the vise holders 630; and
guiding and being biased against the first left wing of the first polymer lever and the second left wing of the second polymer lever towards the lower receiver of the firearm to lock the lower receiver of the firearm with the second section of the main body 640.

In still some embodiments, the step of pivotally coupling the first polymer lever with the second polymer lever on the main body of the vise block by the affixing pin 610 may comprise steps of:
aligning a first main portion of the first polymer lever with a second main portion of the second polymer lever 611;
deposing the first main portion and the second main portion inside an opening cavity formed on a middle portion of the main body 612;
arranging the first polymer lever on a first side portion of the main body 613;
arranging the second polymer lever on a rear side portion of the main body 614; and
passing the affixing pin through a middle through hole of a middle portion of the main body, a first through hole of the first main portion, and a second through hole of the second main portion 615.

It should be noted that, in some embodiments, the middle portion of the main body may be formed between the first section and the second section, wherein the rear side portion may be formed on an opposite side of the front side portion.

In still some embodiments, the step of inserting the second section of the main body of the vise block into the lower receiver of the firearm 620 may comprise steps of:
squeezing a first right wing of the first polymer lever and a second right wing of the second polymer lever by the pair of the vise holders 621.

It should be noted that, in some embodiments, the first right wing may be integrally extended through the first main portion to form the first left wing, and the second right wing may be integrally extended through the second main portion to form the second left wing.

Alternatively, in still some embodiments, the method of using the vise block for self-tightening the lower receiver of the firearm on the pair of vise holders may further comprise steps of:
inserting the first section into the lower receiver 650;
squeezing the second section of the main body by the pair of vise holders 660;
squeezing the first left wing and the second left wing by the pair of the vise holders 670;
   and
guiding the first right wing and the second right wing to be biased against the lower receiver of the firearm 680.

Accordingly, the first right wing of the first polymer lever may be upwardly and integrally extended from the first main portion of the first polymer lever and the first left wing may be upwardly and integrally extended from the first main portion, wherein the second right wing of the second polymer lever may be upwardly and integrally extended from the second main portion of the second polymer lever and the second left wing may be upwardly and integrally extended from the second main portion.

Accordingly, the first section may comprise the first width “h1” defined between the first free end “D” to the second free end “C” and the second section comprises the second width “H” defined between the third free end “B” to a fourth free end “A”, wherein the second width “h1” may be longer than the first width “H”.

Accordingly, the main body may comprise the front face, the rear face formed on an opposite side of the front face, the left face integrally extended between the front face and the rear face and defining the left length “L”, and the first right face defining the first right length “l1”, wherein the left length “L” may be longer than the first right length “l1”.

Accordingly, the second section may comprise the first front face inwardly and vertically indented from the first right face to form the first front face, wherein the first front face may be vertically extended towards the front face of the main body to form the second right face, wherein the first front face and the second right face define an indented section, wherein the second right face defines the second right length “l2”, wherein the left length “L” may be equal to a total of the first right length “l1” and the second right length “l2”.

It should be noted that the front face may define the first width “h1”, and the first front face may define a third width “h2”, wherein the first width “h1” is longer than the third width “h2”. In some embodiments, the second width “H” may be equal to a total of the first width “h1” and the third width “h2”.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more, or different elements, which are disclosed herein even when not initially claimed in such combinations.

Thus, specific embodiments and applications of the multi-caliber self-tightening vise block for the lower receiver of the firearm have been disclosed. It should be apparent, however, to those skilled in the art that many more modifications besides those already described are possible without departing from the disclosed concepts herein. The disclosed embodiments, therefore, are not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

What is claimed is:

1. A multi-caliber self-tightening vise block for a lower receiver of a firearm, comprising,
an affixing assembly comprising a first polymer lever, a second polymer lever, and an affixing pin configured to pivotally coupled the first polymer lever with the second polymer lever; wherein
the first polymer lever comprises a first right wing and a first left wing and the second polymer lever comprises a second right wing and a second left wing.

2. The vise block of claim 1, wherein the first right wing is integrally extended to form the first left wing, wherein the second right wing is integrally extended to form the second left wing, wherein the first left wing and the second left wing are squeezed by the pair of the vise holders and the first right wing and the second right wing are guided to bias against the lower receiver.

3. The vise block of claim 1, wherein the first right wing is integrally extended to form the first left wing, wherein the second right wing is integrally extended to form the second left wing, the first left wing and the second left wing are squeezed by a pair of the vise holders and the first right wing and the second right wing are guided to bias against the lower receiver.

4. The vise block of claim 1, further comprising a main body having a first section, a second section integrally extended from the first section, a middle portion formed between the first section and the second section, and an opening cavity formed on the middle portion, wherein the affixing assembly is pivotally coupled with the main body by the affixing pin.

5. The vise block of claim 1, wherein the first polymer lever comprises a first main portion received inside the opening cavity and the second polymer lever comprises a second main portion received inside the opening cavity, wherein the first main portion is aligned with the second main portion.

6. The vise block of claim 1, wherein the first right wing is upwardly and integrally extended from one side of a first main portion and the first left wing is upwardly and integrally extended from the other side of the first main portion, wherein the second right wing is upwardly and integrally extended from one side of a second main portion and a second left wing is upwardly and integrally extended from the other side of the second main portion.

7. The vise block of claim 4, wherein the main body comprises a front side portion and a rear side portion formed on an opposite side of the front side portion, wherein the first polymer lever is arranged on the front side portion and the second polymer lever is arranged on the rear side portion.

8. The vise block of claim 4, wherein the middle portion of the main body has a middle through hole, and the first polymer lever comprises a first main portion having a first through hole, and the second polymer lever comprises a second main portion having a second through hole, wherein the affixing pin is passed through the middle through hole, the first through hole, and the second through hole.

9. The vise block of claim 4, wherein the first section comprises a first width defined between a first free end to a second free end and the second section comprises a second width defined between a third free end to a fourth free end, wherein the second width is longer than the first width.

10. The vise block of claim 4, wherein the main body comprises a front face, a rear face formed on an opposite side of the front face, a left face integrally extended between the front face and the rear face and defining a left length, and a first right face defining a first right length, wherein the left length is longer than the first right length.

11. The vise block of claim 4, wherein the second section comprises a first right face inwardly and vertically indented to form a first front face, wherein the first front face is vertically extended towards a front face of the main body to form a second right face, wherein the first front face and the second right face define an indented section.

12. The vise block of claim 4, wherein the first polymer lever comprises a first right wing integrally extended to form a first left wing of the first polymer lever, wherein the second polymer lever comprises a second right wing integrally extended to form a second left wing of the second polymer lever, wherein the first section or the second section is squeezed between a pair of vise holders.

13. A method of using a vise block for self-tightening a lower receiver of a firearm on a pair of vise holders, comprising:
pivotally coupling a first polymer lever with a second polymer lever on a main body of the vise block by an affixing pin;
squeezing a first right wing of the first polymer lever and a second right wing of the second polymer lever by a pair of the vise holders; and
guiding and being biased against a first left wing of the first polymer lever and a second left wing of the second polymer lever towards the lower receiver of the firearm to lock the lower receiver of the firearm with the first polymer lever and the second polymer lever.

14. The method of claim 13, further comprising steps of:
squeezing the first left wing of the first polymer lever and the second left wing of the second polymer lever by a pair of the vise holders; and
guiding and being biased against the first right wing of the first polymer lever and the second right wing of the second polymer lever towards the lower receiver of the firearm.

15. The method of claim 13, wherein the step of pivotally coupling the first polymer lever with the second polymer lever on the main body of the vise block by the affixing pin comprises steps of:
aligning a first main portion of the first polymer lever with a second main portion of the second polymer lever;
deposing the first main portion and the second main portion inside an opening cavity formed on a middle portion of the main body;
arranging the first polymer lever on a front side portion of the main body;
arranging the second polymer lever on a rear side portion of the main body; and
passing the affixing pin through a middle through hole of a middle portion of a main body, a first through hole of the first main portion, and a second through hole of the second main portion; wherein
the middle portion of the main body is formed between the first section and the second section and the rear side portion is formed on an opposite side of the front side portion.

16. The method of claim 13, wherein the first right wing of the first polymer lever is upwardly and integrally extended from one side of a first main portion of the first polymer lever and a first left wing of the first polymer lever is upwardly and integrally extended from the other side of the first main portion, wherein a second right wing of the second polymer lever is upwardly and integrally extended from one side of a second main portion of the second polymer lever and a second left wing is upwardly and integrally extended from the other side of the second main portion.

17. The method of claim 13, wherein the vise block comprises a main body having a first section, a second section integrally extended from the first section, a middle portion formed between the first section and the second section, and an opening cavity formed on the middle portion, wherein the affixing assembly is pivotally coupled with the main body by the affixing pin.

18. The method of claim 17, wherein the first section comprises a first width defined between a first free end to a second free end, and the second section comprises a second width defined between a third free end and a fourth free end, wherein the second width is longer than the first width.

19. The method of claim 17, wherein the main body comprises a front face, a rear face formed on an opposite side of the front face, a left face integrally extended between the front face and the rear face and defining a left length, and a first right face defining a first right length, wherein the left length is longer than the first right length.

20. The method of claim 17, wherein the second section comprises a first right face inwardly and vertically indented to form a first front face, wherein the first front face is vertically extended towards a front face of the main body to form a second right face, wherein the first front face and the second right face define an indented section.
